(19) United States
(12) Patent Application Publication
(10) Pub. No.: US 2001/0044152 A1
(43) Pub. Date: Nov. 22, 2001

(54) Dual beam, pulse propagation analyzer, medical profiler interferometer

(76) Inventor: Gale Burnett, Ferndale, WA (US)

Correspondence Address: ROBERT B. HUGHES, HUGHES & SCHACHT, P.S., 2801 MERIDIAN STREET, SUITE 1, BELLINGHAM, WA, 98225-2412, US

(21) Appl. No.: 09/861,039

(22) Filed: May 18, 2001

Related U.S. Application Data
(60) Provisional application No. 60/205,625, filed on May 18, 2000.

(51) Int. Cl. G01N 35/10

(52) U.S. Cl. 436/43; 422/63; 422/100; 436/180

(57) ABSTRACT

A system for analyzing a large number of biological specimens, where the specimens are positioned in a rotatably mounted disc at receiving locations. Two electromagnetic transmitters are positioned to direct electromagnetic waves from lasers to a monitoring location to contact selected specimens and thus form a modified wave resulting from contact with said specimens. The modified wave is transmitted to an analyzing section.

### RELATED APPLICATIONS

This application claims priority of U.S. Provisional Application Ser. No. 60/205,625, which was filed on May 18, 2000.

### BACKGROUND OF THE INVENTION

A) Field of the Invention

The present invention relates to a system, apparatus and methods for medical diagnostics and research, and more particularly for analyzing a large number of specimens, such as biological specimens.

B) Background Art

In the field of medical diagnostics and research, there are many obstacles that slow down progress toward a medical solution for serious medical conditions. Some of the most significant problems are:

Volume of samples that can be analyzed simultaneously;

Method of handling and preparing samples;

Quality and value of data that can be collected;

Difficulty in conducting multiple kinds of tests;

Data archiving and cataloging;

Keeping track of physical location of samples and ability to repeatably, retrieve known samples;

The system of the present invention may or may not be used universally. However, present analysis indicates that in those areas of diagnosis or research where blood samples or other fluids are analyzed routinely and also in very large quantities, or in other situations where large quantities of specimens must be examined and analyzed, the system, apparatus and method of the present invention can be very efficient and effective.

The present invention provides a system, apparatus and method for at least partially alleviating the problems noted above. More particularly, the system of the present invention comprises a specimen support having a plurality of receiving locations to receive and support biological specimens. The support is removable in a manner to be able to locate each support location with its related specimen at a specimen monitoring location.

There is at least one transmitter arranged to transmit an electromagnetic wave or waves to said monitoring location to have contact with said specimen at the monitoring location.

This causes a modified wave or waveforms resulting from the contact of the wave or waves with the specimen. There is a modified wave receiving and detecting section to receive the modified wave or waves.

### BRIEF DESCRIPTION OF THE DRAWINGS

FIG. 1 is a somewhat schematic view showing the basic components of the system of the present invention;

FIG. 2 is a schematic view showing in more detail the components of the system of the present invention;

FIG. 3 is a plan view showing the disc like sample holder, with the pockets being shown as having a much larger size than the actual size in a preferred embodiment, this being done for purposes of illustration.

### DESCRIPTION OF THE PREFERRED EMBODIMENTS

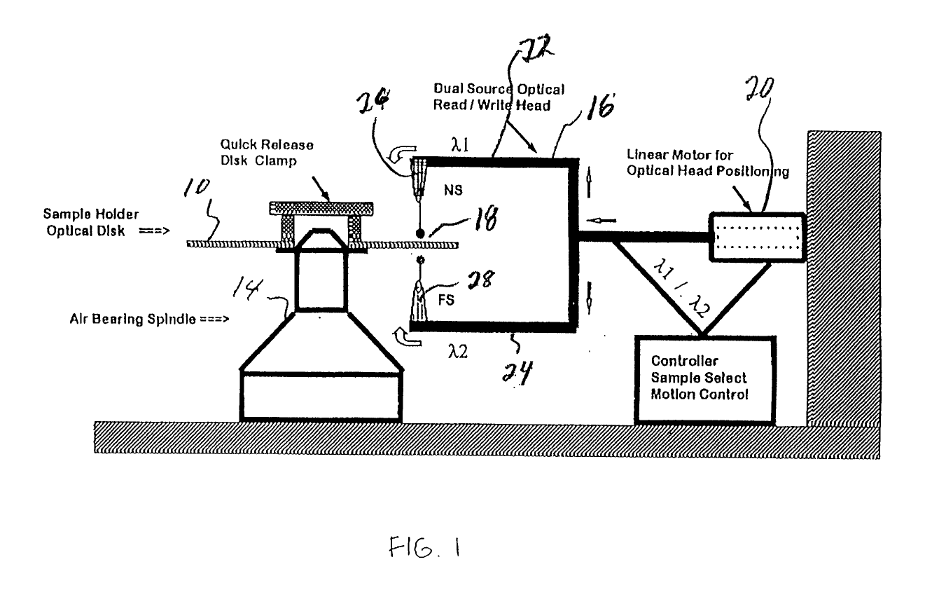

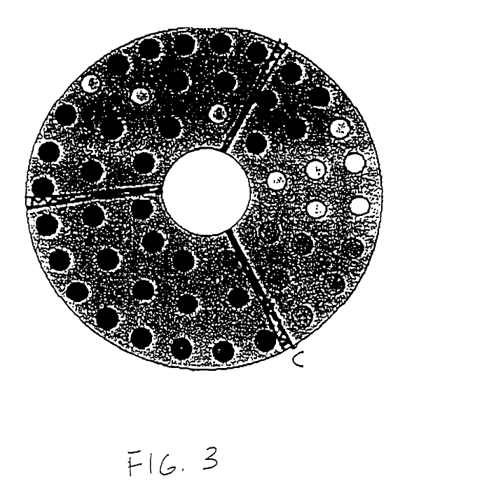

The system of the present invention comprises a specimen support 10 which is shown somewhat schematically in FIG. 1, and also shown in the plan view of FIG. 3. In a preferred form, this support 10 is in the form of a glass CD type disc with uniform micropockets 12 for holding samples. In the plan view of FIG. 3, these pockets 12 are shown to be of a much larger size than in the actual disc which would be used. The surface area of the disc 10 can be approximately 12. 5 square inches, and this could carry over 200 million samples which could be processed nearly simultaneously. This is under computer control, and all samples could be monitored regularly or randomly.

For 200M samples, the diameter of each pocket can be as large as 8 microns and still allow space between the samples to provide discrete sample separation. This leaves approximately 55% of the surface unused. This is sufficient for most organic samples. Particularly where the amount of sample material is very limited, as in many DNA samples, single cells can be tested with the same accuracy as larger samples that might exhaust the supply of the sample. If the sample size space is reduced by a factor of 10, then 20M samples could be placed on 5% of the disk surface. Such enormous sampling capacity may not have a practical value in the local hospital, but in the search for a cure for aids, cancer, diabetes, or other hard to solve medical conditions, being able to conduct millions of tests simultaneously could reduce the research time by many years.

This disc is rotatably mounted about a support generally indicated at 14. To “read” or analyze the specimens on the pockets 12 to the disc 10, there is provided a read/write head 16 adjacent to a monitoring location 18. This read/write head is positioned by use of a linear motor 20.

The read/write head has upper and lower support arms 22 and 24, with the upper support arm 22 carrying at its outer end an electromagnetic wave transmitter 26, and the other arm 24 carrying at its outer end a second electromagnet transmitter 28. These transmitters 26 and 28 each direct electromagnetic wave or waves, or pulses toward the monitoring location 18.

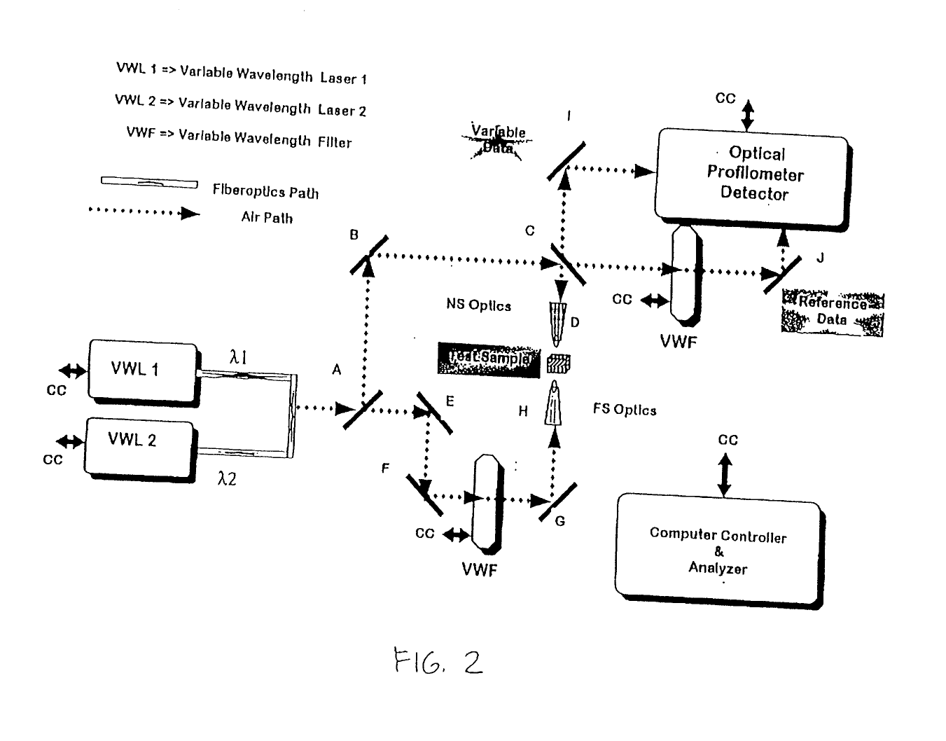

FIG. 2 shows a schematic overview of the detection process. Basically two wavelengths, lambda 1 (L1) and lambda 2(L2) are separated and routed one to the NS (near side) location and the other to the FS (far side) location (see FIG. 1). They pass through respective transmitters 26 and 28, with the sample or specimen centered between them. Pertinent information is then extracted. FIG. 2 shows schematically the detailed design of this process. Two variable wavelength lasers (VWL1 and VWL2) have their outputs combined optically using fiber optics cables. AT point “A” the propagating light waves pass through the air into a 50% reflective, 50% transmission steering mirror. L1 and L2 splits at point “A” to propagate along the air path, ABCD, off front surface mirrors until they impinge on the sample. The other half of L1 and L2 propagates along AEFGH until it impinges on the sample between “D” and “H”. (Note: The 100% mirror at “E” is insert to an adjustment for optical path length. In practice, optical paths ABCD and AEFGH will be absolutely identical so that the intersection point will occur exactly in the plane of the sample. (Note: this sample is one of the 200M pockets in the glass disk sample holder).

Note, that in the ABCD path, L1 and L2 are propagating simultaneous in the air path. Along path AEFGH the optical filter, VWF, makes it possible to allow L1, L2, or L1 and L2 to reach the sample. The 50% mirror at “C” has an important function, even though it is a very familiar optical read/write head configuration. It reflects both L1 and L2 onto the sample between “D” and “H”. It allows the filtered wavelength from path AEFGH, that passes through the sample, to combine with the reflected wavelength from path ABCD and the composite light waves to travel up through the 50% mirror at “C”, off the 100% mirror at “I” and into the medical profiler interferometer. Another function of the 50% mirror at “c” is to allow half of the light energy to pass straight through to the right where it reflects off the 100% reflective steering mirror at “j” to be used as a reference in the medical profiler interferometer.

In the mode of operation where the two wavelengths (L1 and L2) intersect at the location of the sample, present analysis indicates that this results in constructive interference, defraction, refraction, reflection, etc. at the point of intersection. It is further surmised that this has an effect on the continuing waveform such that valuable information can be obtained about the quality and/or condition of an anomaly at the intersection point. Alternatively, only one of the wavelengths L1 and L2 would pass through the sample and this single wavelength would be modified in some manner, depending upon the quality and/or condition of the sample.

The advantages of PPA-MPI (Medical Profiler Interferometer) over other systems are:

1. It provides increased sensitivity to subtle changes in sample characteristics.

2. Reflection and transmission characteristics of samples can be observed independent of and coincident with the same or phase shifted wavelengths. The difference between the photochemical response with one wavelength impinging on the sample versus two wavelength can be totally different, yielding additional valuable information.

3. Rapid comparisons of subtle changes in millions of samples can be made quickly and rapidly.

4. Sample loading, addition of reagents, and positioning of medical profiler detection optics all take advantage of optical disk technology precision servo positioning with controllers, software, etc. to rapidly move laser scanning optics rapidly, accurately, and repeatably to millions of sample locations.

5. Under computer control, spectral response information can be indexed and cataloged.

6. For correlation testing, a few thousand tests could be conducted on urine samples in one section of the disk, a few thousand corresponding blood samples could be on another part of the disk, several thousand single cell tissue studies could be on another part of the disk, and perhaps a different look at DNA related tested on another disk. All of these samples could be from people with common medical problems, indexed by region of the country, age, sex, ethnic background, etc. Control samples could be included on the same disk at a different location. With a quick release mechanism, a completely different disk is inserted with similar correlation data on a different disease or medical condition, i.e. aids, cancer (a, b, c, d), Alzheimer, diabetes, etc.

7. Through common database structure, research information from all over the world can be cross-correlated. For example, there are centers concentrating on one area of research with thousands, even millions of test samples.

8. Volume of tests is a plus, but the nature and quality of testing using dual split beams that intersect in the sample from two directions promises additional information on even a single sample. The ability to run one test or a million on the same instrument with improved information makes it desirable for any diagnostics or research laboratory.

It is obvious that various modifications could be made to the present invention without departing from the basic teachings thereof.

Now Therefore I claim:

1. A system for analyzing specimens, such as biological specimens, comprising:
a) a specimen support having a plurality of receiving locations to receive and support biological specimens and being moveable to locate each support location with its related specimen at a specimen monitoring location;
b) at least one transmitter arranged to transmit an electromagnetic wave or waves to said monitoring location to have contact with said specimen at the monitoring location, with this causing a modified wave or waves resulting from said contact;
c) a modified wave receiving and detecting section to receive said modified wave or waves;

2. The system as recited in claim 1, where said support comprises a planar support carrier with a plurality of receiving pockets therein to receive the specimens.

3. The system as recited in claim 1, wherein said planar carrier comprises a rotatably mounted disc.

4. The system as recited in claim 1, wherein said transmitter is arranged to transmit an electromagnetic wave from a laser source.

5. The system as recited in claim 1, wherein there is a first transmitter and a second transmitter, positioned on opposite sides of said support, said two transmitters directing electromagnetic waves or waves, or pulses, to said monitoring location to create an interfering wave pattern for analysis.

6. The system as recited in claim 5, wherein there is a laser source to transmit a laser beam or beams to said two transmitters.

7. The system as recited in claim 5, wherein said transmitters receive electromagnetic energy of varying frequency.

8. The system as recited in claim 1, wherein there is a source of electromagnetic energy which is a laser beam, and there is a semi-reflective mirror system to receive said laser beam and to transmit said laser beam to said transmitters.

9. The system as recited in claim 8, wherein said mirror system transmits a reference wave to said receiving and detecting section for purposes of wave analysis.

10. The system as recited in claim 1, wherein said receiving and detecting section comprises an interferometer section for analyzing said modified wave.

11. A method for analyzing specimens, such as biological specimens, said method comprising:
a) depositing a plurality of specimens on a support having a plurality of receiving locations to receive said specimens at support locations;
b) moving said support to various positions to locate selected receiving locations at a monitoring location;
c) transmitting an electromagnetic wave or waves toward said monitoring location to have contact with the specimen at the monitoring location to cause a modified wave or wave forms resulting from said contact to be formed;
d) receiving said modified wave or waves and directing these to a receiving and detecting section.
